(19) United States
(12) Patent Application Publication
(10) Pub. No.: US 2024/0081287 A1
(43) Pub. Date: Mar. 14, 2024

(54) CLIPPER BRUSH FOR COMPANION ANIMAL

(71) Applicant: JUAN LEE, Gwangju (KR)

(72) Inventor: JUAN LEE, Gwangju (KR)

(21) Appl. No.: 17/992,969

(22) Filed: Nov. 23, 2022

(30) Foreign Application Priority Data
Sep. 14, 2022 (KR) 10-2022-0115548

(51) Int. Cl. A01K 13/00; B26B 21/16

(52) U.S. Cl. CPC A01K 13/002; B26B 21/16; A46B 2200/1093

(57) ABSTRACT

A clipper brush includes a main body part having a space receiving hair of the companion animal, a cover covering the main body part and providing the storage space above the main body part, a push part provided to be movable in a sliding manner at the main body part and pressed and moved by a user' hand, a rotating body part connected to the push part and rotating in conjunction with sliding movement of the push part, and a clipper part cutting the hair while reciprocating in the sliding manner by rotation of the rotating body part. The clipper brush allows a user to remove the hair by pressing the push part without operation of a motor, etc., so that the user can groom and remove the hair in a comfortable state without noise or stress.

### CROSS REFERENCE TO RELATED APPLICATION

The present application claims priority to Korean Patent Application No. 10-2022-0115548, filed Sep. 14, 2022, the entire contents of which is incorporated herein for all purposes by this reference.

### BACKGROUND OF THE INVENTION

### Field of the Invention

The present disclosure relates generally to a clipper brush for a companion animal. More particularly, the present disclosure relates to a clipper brush for a companion animal, the clipper brush being capable of brushing hair of the companion animal, and easily cutting long hair without causing pain to the companion animal due to noise such as motor driving sound so that the use thereof is easy and the management is efficient.

### Description of the Related Art

In general, companion animals have hair, and companion animals with long hair have a problem of being a medium for fleas or germs. Furthermore, the companion animal's hair can become a factor contaminating the surrounding environment.

Furthermore, for companion animals, especially cats, hairballs that are formed by gathering hair in the stomach when a cat grooms the cat's hair can cause vomiting, nausea, diarrhea, etc., and can even cause death.

In order to solve the problem, as a related art for grooming companion animal's hair, a device connected to a vacuum cleaner to groom and suction the hair has been proposed.

However, in the related air, since a companion animal's hair is groomed using the vacuum cleaner, operation of the vacuum cleaner is essential when grooming the companion animal's hair, and the companion animal with sensitive hearing has anxiety due to operating noise of the vacuum cleaner, making it difficult for the user to groom the companion animal's hair in a stable posture. Accordingly, there is inconvenience of having to anesthetize the companion animal or have an expert perform the companion animal grooming.

### SUMMARY OF THE INVENTION

The present disclosure has been made keeping in mind the above problems occurring in the related art, and the present disclosure is intended to provide a clipper brush for a companion animal, wherein the clipper brush is capable of grooming and removing the companion animal's hair in a comfortable state without noise or stress to the companion animal.

Another objective of the present disclosure is to provide a clipper brush for a companion animal, wherein the clipper brush is capable of removing the companion animal's hair easily and safely without anesthesia, and of easily collecting and managing the companion animal's hair being scattered around a room.

In order to achieve the above objectives, according to one aspect of the present disclosure, there is provided a clipper brush for a companion animal, and the clipper brush include: a main body part having a space in which companion animal's hair; a cover configured to cover the main body part and providing the storage space between the cover and the main body part; a push part provided to be movable in a sliding manner at the main body part and configured to be pressed and moved by a user's hand; a rotating body part connected to the push part and configured to rotate in conjunction with sliding movement of the push part; and a clipper part configured to cut the companion animal's hair while reciprocating in the sliding manner by rotation of the rotating body part.

According to the present disclosure having the above-described configuration, the non-electric clipper brush for a companion animal allows a user to remove the companion animal's hair by pressing the push part without operation of a motor, etc., so that the user can groom and remove the companion animal's hair in a comfortable state without noise or stress to the companion animal.

Furthermore, by the clipper brush for a companion animal according to the present disclosure, since the user can groom and cut the companion animal's hair while removing the companion animal's hair, the user can easily and efficiently groom the companion animal's hair.

Furthermore, when the user removes the companion animal's hair, hair scattered around a room can be easily collected, and management is easy.

### BRIEF DESCRIPTION OF THE DRAWINGS

FIG. 1 is a perspective view showing a non-electric clipper brush for a companion animal according to the present disclosure.

FIG. 2 is a sectional view of FIG. 1.

FIG. 3 is a partial exploded-perspective view showing a main body part, a push part, and a rotating body of the present disclosure.

FIG. 4 is a side view showing the rotating body and a clipper part of the present disclosure.

FIG. 5 is a view showing the clipper part of the present disclosure.

### DETAILED DESCRIPTION OF THE INVENTION

Hereinbelow, a non-electric clipper brush for a companion animal according to the present disclosure will be described in detail as an embodiment with reference to accompanying drawings.

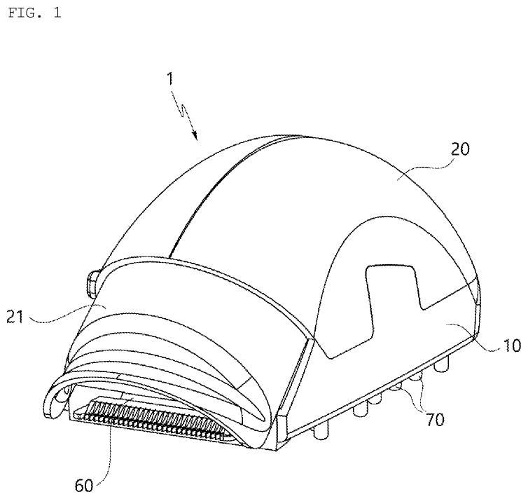

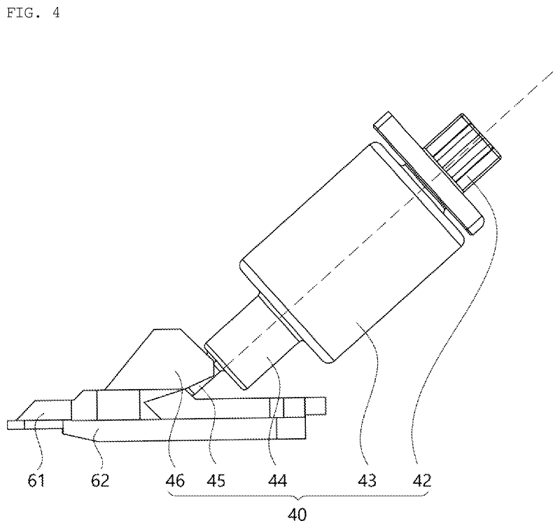

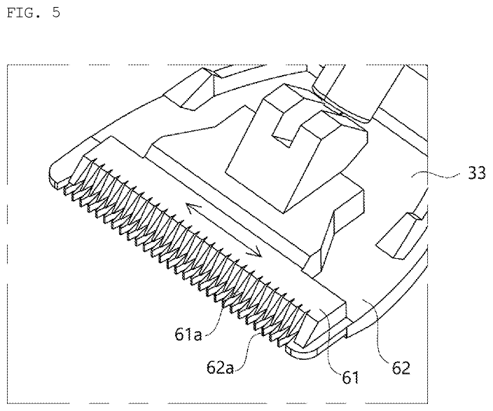

Referring to FIGS. 1 to 5, according to the present disclosure, a clipper brush 1 for a companion animal includes a main body part 10, a cover 20, a push part 30, a rotating body part 40, an elastic part 50, and a clipper part 60.

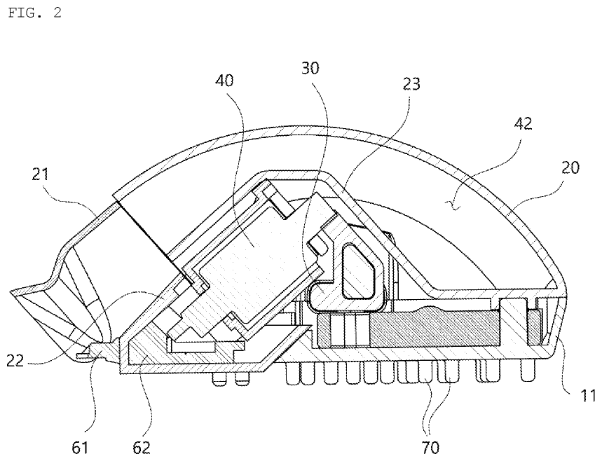

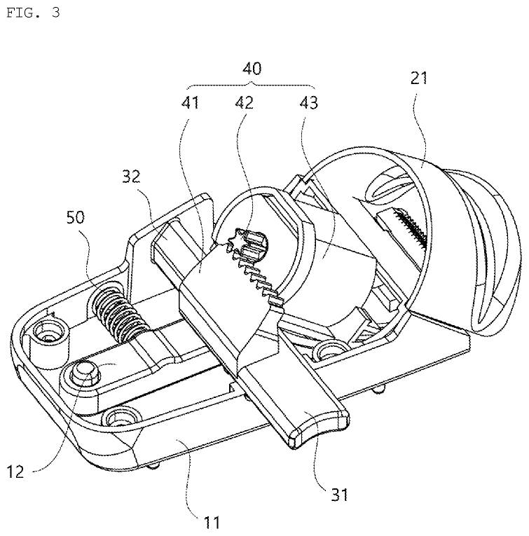

The main body part 10 may be formed in a rectangular shape and edges thereof are rounded in arc shapes, as shown in FIGS. 2 and 3.

The main body part 10 includes a main body frame 11 providing a bottom plate, and edge portions of the main body frame 11 are formed to be bent upward so as to accommodate the push part, the elastic part, and the clipper part.

The elastic part 50 is installed at one portion of the main body frame 11. For example, the elastic part 50 is formed of an elastic spring, and is inserted over a protrusion on the main body frame 11 to be stably disposed. A second portion of the elastic part 50 is configured to press a support part in contact with the support part, which will be described below.

The main body frame 11 includes the support part 12 therein. The support part 12 is formed in a long shape along a longitudinal direction at a transversely intermediate position of the main body frame 11, as shown in FIG. 3. The support part 12 may be formed in a rod shape, and a first end is pivotably fastened to a pin installed by standing on a rear end side of the main body frame 11. A second portion of the support part 12 is configured to support the push part, and is in contact with a protrusion (not shown) protruding downward from a lower surface of the push part 30. When the push part slides, the support part is pivoted on the pin, and when external force applied to the push part is removed, the support part is pivoted back to the original position by elastic pressure of the elastic part 50.

The cover 20 is installed at an upper portion of the main body part 10.

The cover 20 is configured to cover the main body part and has a storage space 24 between the main body part and the cover.

As shown in FIGS. 1 and 2, the cover 20 is formed into an arc shape in a direction from a front portion to a rear portion of the main body part, and an entrance cover 21 is formed at a front portion of the cover 20.

A front end of the entrance cover 21 is bent upward so as to stably guide entering companion animal's hair.

At a position where the entrance cover 21 is provided, at the front portion of the main body part, an inclined guide plate 22 is provided between the main body part and the entrance cover. The inclined guide plate 22 is formed to be upwardly inclined toward the rear side so that the cut hair of the companion animal can be smoothly guided and accommodated in the storage space without being scattered.

An end of the inclined guide plate 22 is connected to a storage partition 23 bent downward, and the storage space is defined by the storage partition and the cover.

A brush 70 is installed on a lower surface of the main body part 10. The brush 70 is formed by protruding downward from the lower surface of the main body part. The brush 70 is disposed while being spaced at intervals, and when a user uses the non-electric clipper brush 1, the brush is moved and grooms the companion animal's hair, and massages the companion animal.

At the main body part 10 the push part 30 is installed to be movable with respect to the main body part in a sliding manner. The push part 30 is formed to protrude outward from the main body part 10 so as for the user to press the push part 30 by a hand to move the push part 30, and the push part 300 is configured to be slidably movable toward the main body part in a pushing operation.

The push part 30 includes a first push main body 31 and a second push main body 32. The first push main body 31 may be formed in a rod shape, and the protrusion in contact with the support part is formed downward on a lower surface thereof. The first push main body 31 is formed to be inserted into an opening formed by cutting a lateral wall of the main body frame 11, and an insertion hole is formed in a second portion of the push main body.

The second push main body 32 is formed to have a size smaller than the first push main body so as to be inserted into the insertion hole of the first push main body 31. A first portion of the second push main body 32 is supported by a lateral wall of the main body part and a second portion thereof is inserted into the insertion hole formed in the first push main body.

The second push main body is inserted into the insertion hole to support the first push main body 31 so that the first push main body 31 in a sliding movement is moved in a sliding manner without shaking and separation from a regular position.

The push part 30 is connected to the rotating body part 40 rotating in conjunction with sliding movement of the push part.

The rotating body part 40 includes a rack part 41, a pinion part 42, a rotating body 43, a rotating shaft 44, an eccentric protrusion 45, and a fastening bracket 46.

The rack part 41 is formed to protrude upward from an upper surface of the first push main body 31 and is integrally formed with the first push main body. A plurality of gear teeth is formed on an upper surface of the rack part 41.

The pinion part 42 is formed to protrude on an end of the rotating body 43 and a plurality of gear teeth engaged with the gear teeth of the rack part 41 is formed on an outer circumferential surface of the pinion part 42.

The pinion part 42 is concentrically connected to the rotating shaft 44. The rotating body 43 is formed to surround the rotating shaft 44, and is formed concentrically to the rotating shaft and the pinion part.

A first end of the rotating shaft 44 is connected to the pinion part and a second end of the rotating shaft is connected to the eccentric protrusion 45.

The eccentric protrusion 45 is connected to the rotating shaft 44 eccentrically in one direction from the rotating axis, and in rotation of the rotating shaft 44, the eccentric protrusion is configured to rotate in a circular shape around the center shaft of the rotating shaft.

A second end of the eccentric protrusion 45 is connected to the fastening bracket 46. The fastening bracket 46 is installed by standing on an upper clipper, which will be described below. For example, the fastening bracket 46 may be formed into a pair of brackets installed by standing at a predetermined interval, and the second end of the eccentric protrusion is inserted into a gap between the pair of fastening brackets and is fastened thereto.

The clipper part 60 is provided below the fastening bracket. The clipper part is configured to cut the companion animal's hair while sliding in conjunction with rotation of the rotating body part.

The clipper part 60 includes an upper clipper 61 supporting the fastening bracket 46, and a lower clipper 62 fixed at a front surface of the main body part.

When the eccentric protrusion rotates in a circle around the center shaft of the rotating body, the fastening bracket connected to the eccentric protrusion reciprocates leftward and rightward with a predetermined width, and the upper clipper 61 connected to the fastening bracket reciprocates leftward and rightward to be moved in the sliding manner.

The upper clipper 61 includes a plurality of upper clipper blades 61a having a tip formed forward, and the lower clipper 62 includes a plurality of lower clipper blades 62a corresponding to the plurality of upper clipper blades.

When the lower clipper is fixed to the main body part, the user presses the push part to allow the upper clipper 61 to reciprocate leftward and rightward in a sliding manner by rotation of the rotating body. Then, the companion animal's hair inserted into cutting grooves of the upper clipper blades and the lower clipper blades is cut between the clipper blades by reciprocating movement of the upper clipper, and cut hair is moved along the inclined guide plate 22 and stored in the storage space 24.

With the above-described configuration, the user can groom the companion animal's hair and cut the hair at the same time, so that the user can groom and remove the companion animal's hair in a comfortable state without noise or stress to the companion animal.

Furthermore, with the provision of the guiding space and the storage space, when the user removes the companion animal's hair, the hair scattered around a room can be easily collected, and the management is easy.

Although the embodiment only clearly illustrates a part of the technical idea included in the present disclosure, it is obvious that all modifications and specific embodiments that can be easily inferred by those skilled in the art within the scope of the technical idea included in the specification of the present disclosure are included in the technical idea of the present disclosure.

What is claimed is:

1. A clipper brush for a companion animal, the clipper brush comprising:
a main body part having a space in which hair of the companion animal is stored;
a cover configured to cover the main body part and providing the storage space between the cover and the main body part;
a push part provided to be movable in a sliding manner at the main body part and configured to be pressed and moved by a user's hand;
a rotating body part connected to the push part and configured to rotate in conjunction with sliding movement of the push part; and
a clipper part configured to cut the companion animal's hair while reciprocating in the sliding manner by rotation of the rotating body part.

2. The clipper brush of claim 1, wherein the push part comprises:
a first push main body supported by the main body part and inserted to protrude outward from the main body part, and
a second push main body of which a first portion is supported by a lateral wall of the main body part and a second portion is inserted into an insertion hole formed in the first push main body to support the first push main body.

3. The clipper brush of claim 2, wherein the first push main body is configured to be slidably inserted into the main body part via an opening formed on the main body part.

4. The clipper brush of claim 2, wherein the rotating body part comprises:
a rack part integrally formed in the first push main body and having a plurality of gear teeth formed at an upper end thereof; and
a pinion part having a plurality of gear teeth engaged with the plurality of gear teeth of the rack part.

5. The clipper brush of claim 4, wherein the rotating body part further comprises:
a rotating body supporting the pinion part and concentrically connected to the pinion part;
a rotating shaft concentrically connected to a lower end of the rotating body;
an eccentric protrusion eccentrically connected to a lower end of the rotating shaft; and
a fastening bracket provided by standing on the clipper part and to which the eccentric protrusion is securely fastened.

6. The clipper brush of claim 5, wherein the clipper part comprises:
an upper clipper supporting the fastening bracket; and
a lower clipper fixed to a front surface of the main body part,
wherein when the eccentric protrusion rotates in a circle on a center shaft of the rotating body, the upper clipper reciprocates leftward and rightward in a sliding manner.

7. The clipper brush of claim 6, wherein the upper clipper comprises an upper clipper blade of which a tip is formed forward thereof, and
the lower clipper comprises a lower clipper blade corresponding to the upper clipper blade.

8. The clipper brush of claim 1, further comprising:
a plurality of brush protrusion parts formed by protruding on a lower surface of the main body part.

9. The clipper brush of claim 2, wherein the main body part comprises:
a main body frame providing a bottom surface and a lateral wall; and
a support part provided on the bottom surface of the main body frame and supporting the first push main body while being in contact with the first push main body,
wherein the support part is fixed at a rear surface of the main body frame by a pin and configured to be pivoted when the first push main body moves in a sliding manner.

10. The clipper brush of claim 9, further comprising:
an elastic part of which a first portion is supported by the main body frame and a second portion is in contact with the support part and provides an elastic force to the support part.

11. The clipper brush of claim 1, wherein an inclined guide plate is provided at a front portion of the main body part, and the inclined guide plate is formed between the main body part and an entrance cover and is disposed at an inclination.
